(19) United States
(12) Patent Application Publication
(10) Pub. No.: US 2005/0088997 A1
(43) Pub. Date: Apr. 28, 2005

(54) Wireless communication arrangements with a discovery procedure

(76) Inventor: Diego Melpignano, Monza (IT)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/505,491

(22) PCT Filed: Jan. 24, 2003
(86) PCT No.: PCT/IB03/00334

(30) Foreign Application Priority Data
Feb. 20, 2002 (EP) 02075688.8

(51) Int. Cl. H04Q 7/24

(52) U.S. Cl. 370/338

(57) ABSTRACT

A Communications arrangement is disclosed, which comprises a first communications device in the form of an access point AP1. The access point AP1 is adapted to look for further communications devices in range for connection thereto by transmission of an inquiry message IQ1 in accordance with a predetermined protocol, which in the specific example given is the Bluetooth protocol. A mobile terminal MT1 which receives the inquiry message IQ1 replies with an identifier. On receipt of the identifier, the access point AP1 is adapted to page PG1 the mobile terminal MT1 and thereby to establish interaction IA1 therebetween. The access point AP1 includes a group of radio communications modules (14, 16, 18) which are configured at least temporarily to perform individual wireless communications tasks. The connection establishment procedure is divided among the modules (14, 16, 18), which cooperate with each other and comprise at least one each of an inquirer module (14), a pager module (16) and an interactor module (18).

The present invention relates to wireless communication arrangements and methods of operating the same, in particular to a communications arrangement and a method of operating the same in which a first communications device searches for further communications devices by wireless transmission of an inquiry message, a further wireless device in receipt of a said inquiry message replying with an identifier and subsequently being paged by the first communications device.

Wireless communications systems based on radio units and connections used to group them at least temporarily into a shared resource network are known. One current implementation of this general type is in the form of a short-range, frequency-hopping and uncoordinated network and is known in the art as “Bluetooth”™ communications. This arrangement is controlled by the Bluetooth standard and a fall specification for conformity in Bluetooth communications can be found through the Bluetooth Special Interests Group (SIG), whose web site can be found at “www.bluetooth.com” along with the current Bluetooth standard and related information.

A useful discussion of Bluetooth communications can be found in text book form in “Bluetooth, Connect Without Wires” by Jennifer Bray and Charles F. Sturinan, published by Prentice Hall PTR under ISBN 0-13-089840-6.

Further prior art can be found in, for example, WO 01/20940, US5940431 and in US published applications 2001/0005368A1 and 2001/0033601A1, in which some aspects of the current state of the art in this field are also discussed.

The reader is referred to the above mentioned sources for general Bluetooth background information and also, for example, for clarification of terms of art used herein and not specifically defined.

There are two main states that a Bluetooth module/device can be in, referred to in the art as “Standby” and “Connection”. The standby state is the default state in which a Bluetooth device has no links with other devices. In order to establish a link with another Bluetooth device and achieve the connected state, two procedures must be executed sequentially and these are referred to as “Inquiry” and “age”.

Any device may issue an inquiry message and the inquiry phase is used to obtain the address of a potential master or slave unit, the address being referred to as the Device Access Code (DAC). The inquiry procedure does not establish a connection between devices, only the page procedure can do this. The inquiry procedure identifies potential candidates for connection and gathers their addresses. Once a device knows the DAC of a further device, obtained by for example the inquiry procedure, it can page that device. If the paging is successful, the pager and the paged device will enter into the connected state, in which they interact exchanging data packets.

When an access point in some prior art arrangements is required to perform the inquiry and paging operations in sequence, there can be inconvenient delays before connections are made. This is especially so in cases where an access point receives multiple responses to the transmission of inquiry messages or if it receives multiple requests for handoff from already connected slave units. In addition, the same radio module which performs all these functions must also be shared within the or each access point for interaction with the or each slave unit in its piconet. It is therefore desirable to look for arrangements in which speed of response and capacity might be improved over certain of the prior art proposals.

It is an object of the present invention to provide an improved communications arrangement and method of operating the same and in particular an improved communications arrangement and method of operating the same in which a first communications device searches for further communications devices by wireless transmission of an inquiry message, a further wireless device in receipt of a said inquiry message replying with an identifier and subsequently being paged by the first communications device. It is also an object of the present invention to provide an improved communications arrangement and method of operating the same in which a group of wireless modules are included/integrated in a single communications device.

Accordingly, the present invention provides a communications arrangement comprising a first wireless communications device which is adapted to search for further wireless communications devices in range for connection thereto by transmission of an inquiry message in accordance with a predetermined protocol, and a said further wireless device in receipt of a said inquiry message being adapted to reply with an identifier, said first wireless device being adapted on receipt of said identifier to page said further wireless device and thereby to establish interaction therewith, characterized in that said first wireless device includes a group of wireless communications modules each of which is configured at least temporarily to perform an individual wireless communications task, said group comprising at least one each of an inquirer module, a pager module and an interactor module.

Said inquirer module may be dedicated purely to discovery of potential said further wireless devices and may be adapted to perform an inquiry procedure in which it transmits inquiry messages at least periodically and preferably substantially continuously.

The or each said inquiry message may be transmitted twice on two frequencies in one protocol timeslot and an immediately following protocol timeslot may preferably be used to listen for replies from further wireless devices on two corresponding inquiry response frequencies.

Inquiry information collected by said inquirer module and relating to a said discovered potential further wireless device may be communicated to said pager module, which inquiry information enables said pager module to page the or each said potential further wireless device.

After replying to a said inquiry with a said identifier, a said further wireless device may enter into a page scan state in which it waits on a substantially fixed page scan frequency to be paged. The or each page message will be transmitted by a said pager module, although the further wireless radio device will not necessarily know this to be the case and from its point of view will simply be waiting to be paged.

Said pager module may be dedicated purely to establishment of a connection with one or more potential said further radio devices. A said attempted connection may be performed using a paging message based on inquiry information which has previously been collected by said inquirer module and communicated to said paging unit. If inquiry information such as a device address of one or more potential further wireless devices is substantially known to said first wireless device without the need for an inquiry process, said pager module may be adapted to page the or each said substantially known further wireless device directly and without necessarily communicating with said inquirer module.

The or each said paging message may be transmitted twice on two frequencies in one protocol timeslot. An immediately following protocol timeslot may be used to listen for replies from the paged further wireless device. The protocol used may conform to the Bluetooth standard, such that for example a protocol timeslot may be in the region of 625 μS derived from a hopping frequency in the region of 1600 hops per second. However, the present invention is not limited thereto and the wireless transmission may be provided by alternative methods such as diffuse infra-red.

A said potential further wireless device may respond to paging by return of a response packet containing synchronization information about itself, preferably including its device address. Transmission of said response packet may occur substantially immediately on reception of a said paging message. Said response message may also preferably be transmitted a plurality of times.

The establishment of a said connection may include one or more of the setting up of a wireless link, authentication of said further wireless device and a service discovery procedure. On establishment by said pager module of a said connection with a said further wireless device, that further wireless device may be handed over from said pager module to a said interactor module.

A said interactor module may be dedicated purely to interaction between said communications device and a connected said further wireless device, said interaction including for example the exchange of data packets between said interactor module and said connected further device.

At least one existing connection between a said interactor module and a said further wireless device may be substantially unaffected by the performance of respective said tasks by at least one and preferably either of said inquirer and pager modules.

Said inquirer module may be adapted to transmit a further said inquiry message while a said pager module pages a potential said further wireless device which has responded to a said inquiry message transmitted earlier.

A said communications device may include a substantially secure communications channel linking said inquiry, paging and interactor modules for the transfer of data therebetween.

Said pager module may authenticate, or implement a security clearance check on, a paged said further device.

The present invention also provides a method of establishing a wireless connection between a first wireless communications device and one or more further wireless communications devices, said first wireless device having integrated therein a group of at least three wireless communications modules, the method including:
configuring each said module for performing a dedicated wireless communications task, said tasks comprising one per module of inquiring, paging and interacting;
transmitting inquiry messages from an inquirer module of said group;
paging a said further wireless device using a pager module of said group; and
interacting with one or more said further wireless devices using an interactor module of said group.

The present invention also provides a communications device for use in an arrangement or method according to the invention, said device being configurable at least temporarily as a master unit of a communications network and adapted to transmit an inquiry message to look for further communications devices, such as slave units, which are in communications range for connection thereto, characterized in that said first device includes a group of wireless communications modules each of which is configured at least temporarily to perform an individual wireless communications task, said group comprising at least one each of an inquirer module, a pager module and an interactor module.

The first and further communications devices may comprise master and slave units of an area network. For example, they may be example access points and mobile terminals of a network conforming to the Bluetooth standard.

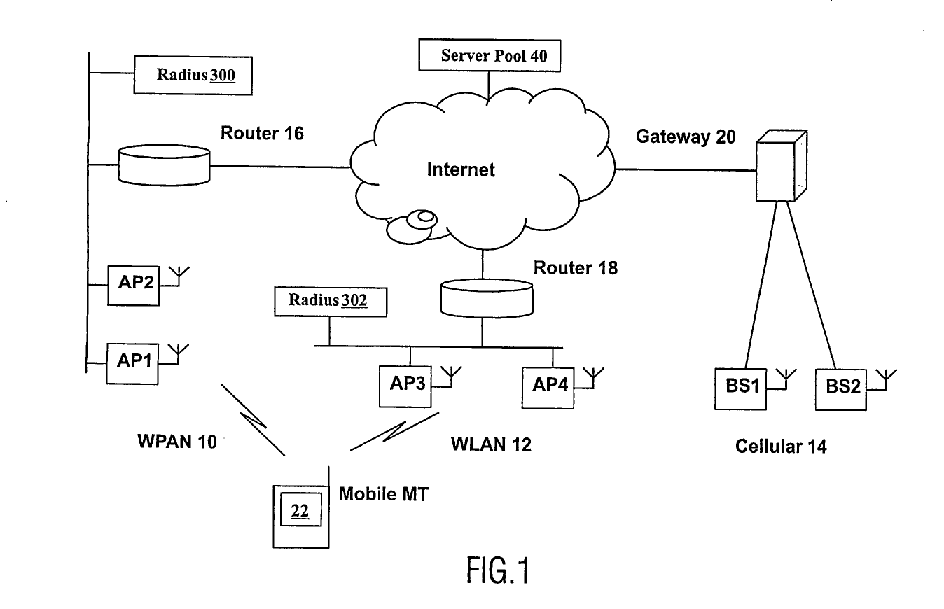

FIG. 1 is a schematic diagram of a communications arrangement;

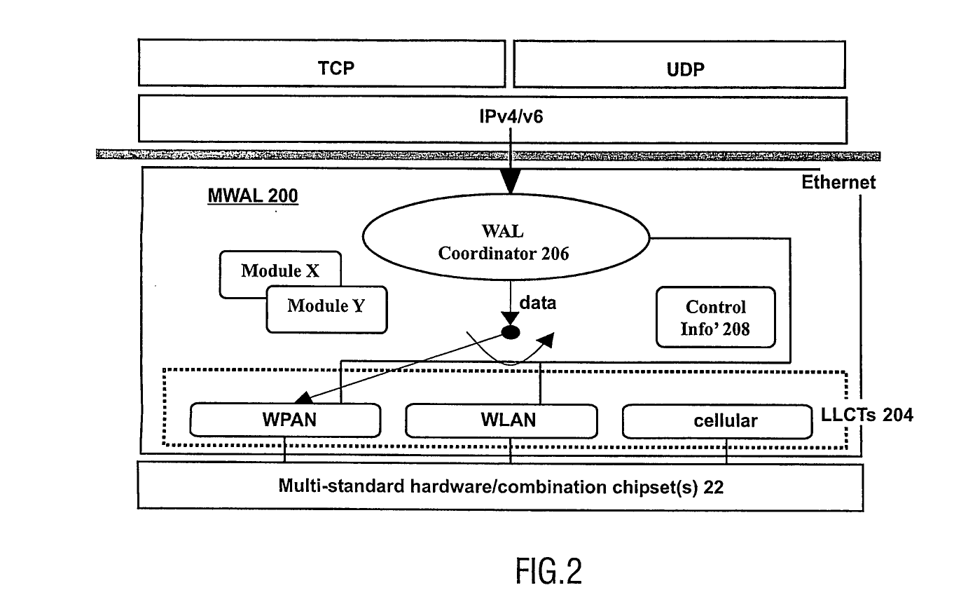

FIG. 2 is a state chart for the arrangement of FIG. 1;

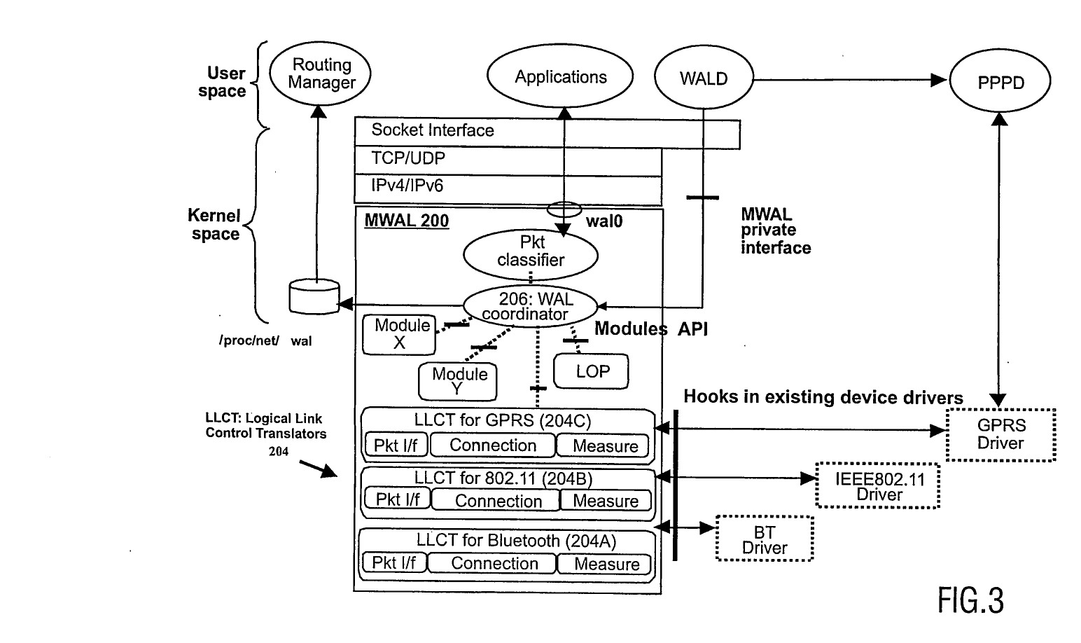

FIG. 3 is a block diagram of part of the arrangement of FIG. 1, showing detail of an embodiment of the present invention; and

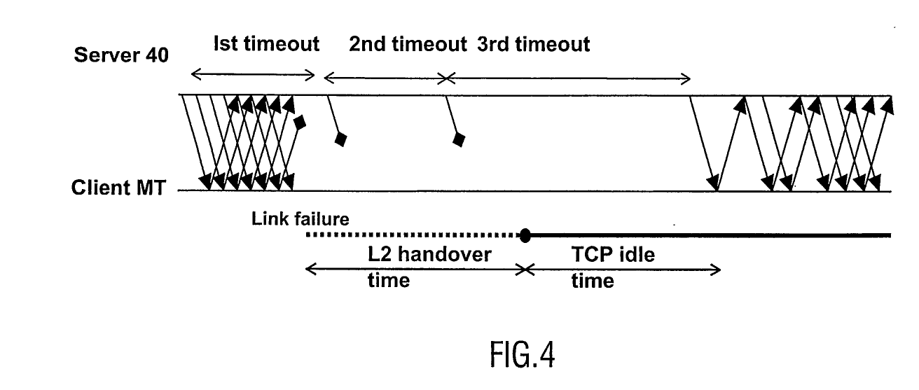

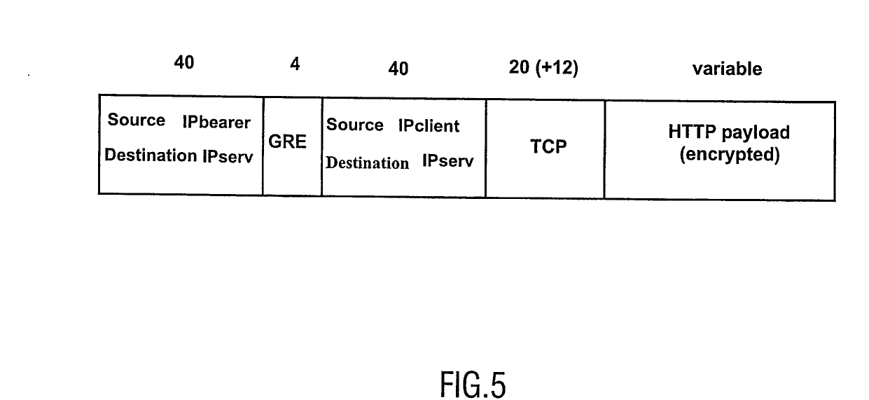

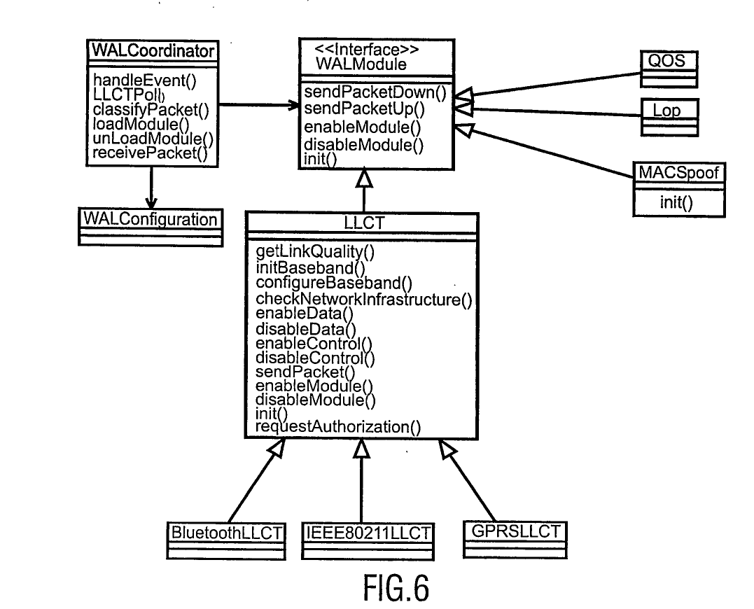

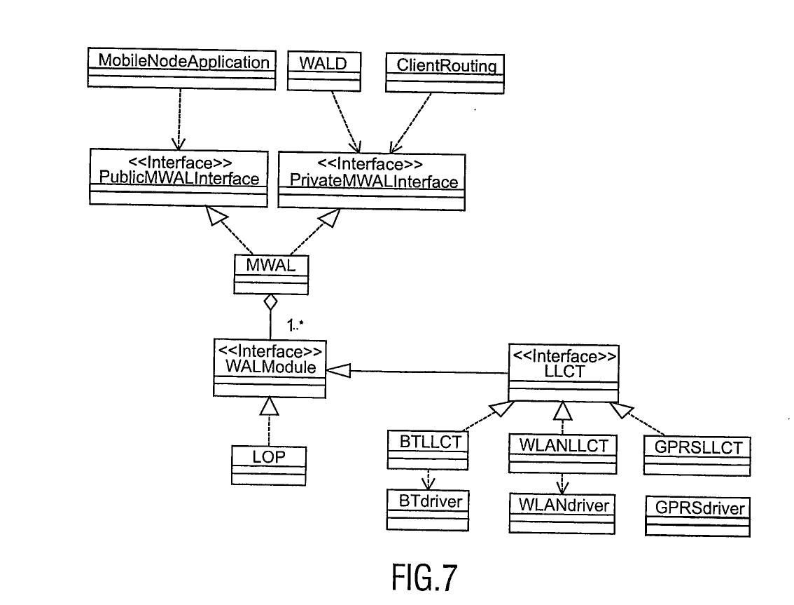

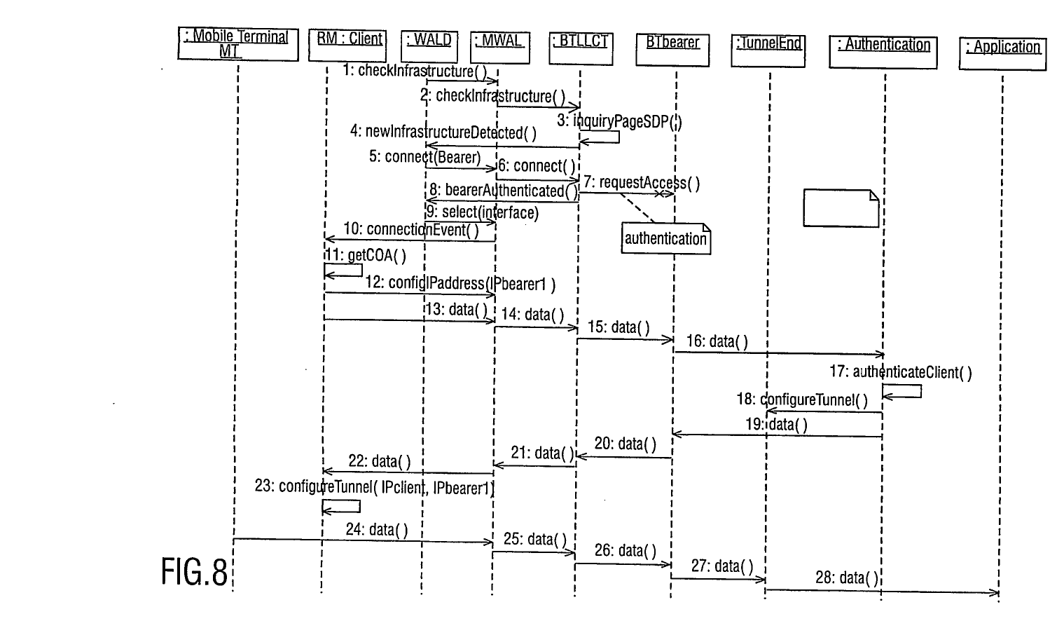

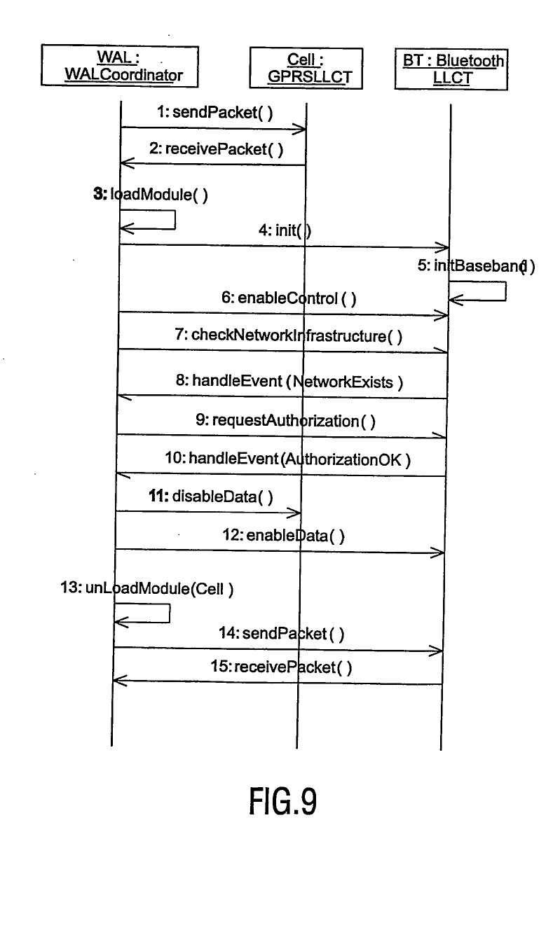

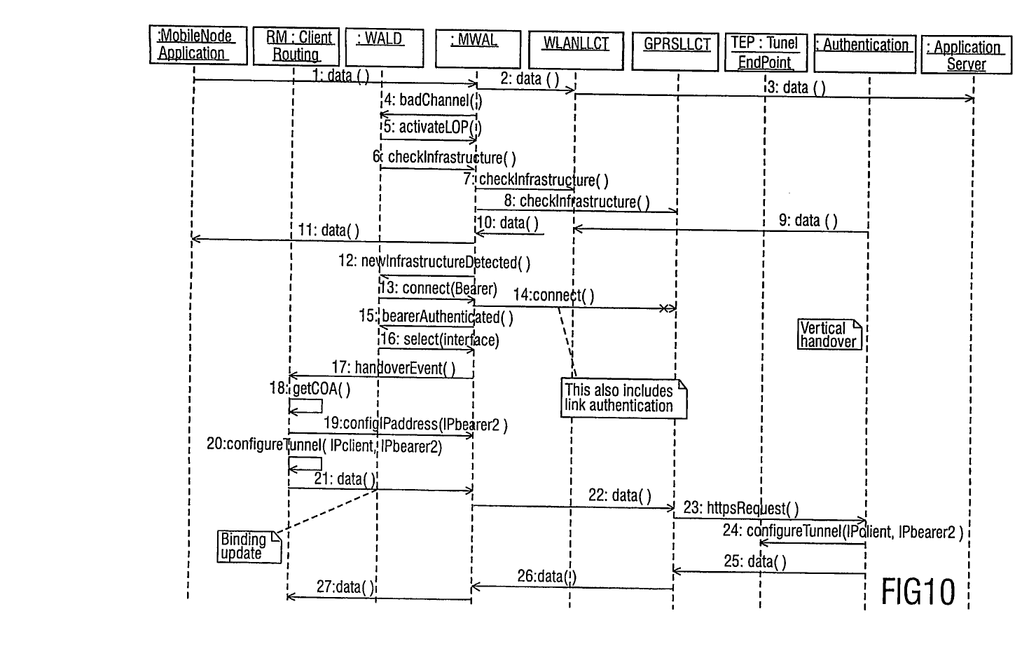

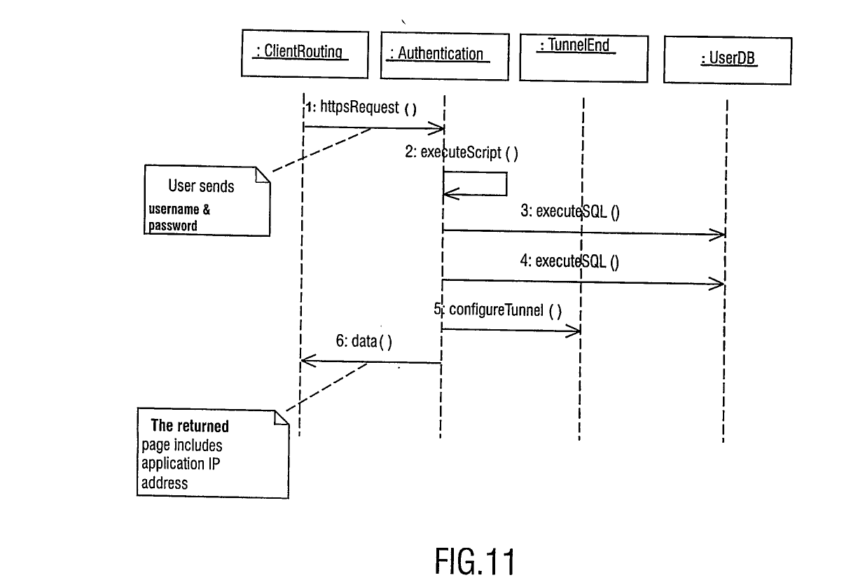

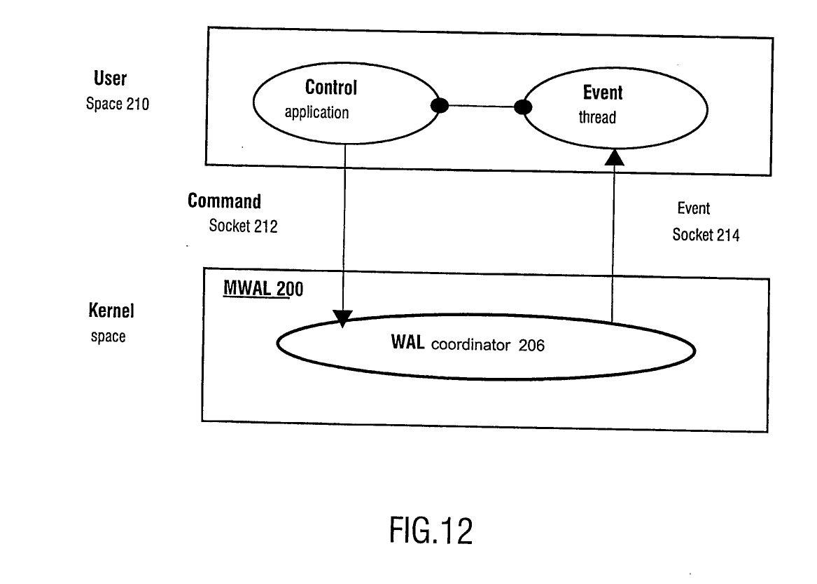

FIG. 4 is a modification to the state chart of FIG. 2 to reflect an aspect of the embodiment of FIG. 3.

The present invention will now be described with reference to certain embodiments and the accompanying drawings, although such description is by way of example only and the present invention is not limited thereto but only by the appended claims. Further, the present invention will be described mainly with reference to a local area network but is not limited thereto. The network may be any form of shared resource network (SRN), i.e. in an SRN hardware resources are shared, and each hardware network element can be accessed from any other network element. An SRN in accordance with the present invention is more-or-less synonymous with a CAN, LAN or WAN, but the term SRN will be used to indicate that the present invention is not limited to specific aspects of known CANs, WAN's or LAN's e.g. contention scheme or whether Ethernet, Token Ring or Wireless LAN. In particular, the present invention relates to a PAN—a personal area network, involving short-range radio connection between mobile units and master units. Also the topology of the PAN, LAN or WAN is not considered a limit on the present invention, e.g. bus physical, star physical, distributed star, ring physical, bus logical, ring logical may all be used as appropriate. Various standards have been produced for LAN's, e.g. EEE 802.3, IEEE 802.4, IEEE 802.5, ANSI X3T9.5 (FDDI, I and II) any of which may find advantageous use with the present invention. LAN and WAN design and construction are discussed in detail in, for example, “Mastering Local Area Networks”, by Christa Anderson and Mark Minasi, SYBEX Network Press, 1999 or “Data Communications, Computer networks and Open Systems”, by Fred Halsall, Addison-Wiley, 1996. Various types of wireless LAN have been standardized or are in general use, e.g. the standards IEEE 802.11, IEEE 802.11HR (Spread Spectrum) and systems based on DECT, Bluetooth, HIPERLAN, Diffuse or point-to-point infra-red. Wireless LAN's are discussed in detail in “Wireless LAN's” by Jim Geier, Macmillan Technical Publishing, 1999.

The term “wireless” includes in accordance with this invention any form of communication which does not require a physical connection such as a wire or wires, a coaxial cable, a fibreoptic cable. For instance the present invention includes the use of diffuse infra-red as a transmission medium.

The present invention is also not limited to only the Bluetooth protocol but includes any suitable protocol for connection orientated (e.g. circuit switched) wireless arrangements which use a spread spectrum technique, such as for example frequency hopping, and lack a true broadcast, beacon or pilot channel. Some such arrangements may also be referred to as uncoordinated cellular systems in which each master unit plays the roll of a base station and a cell can be considered its coverage area Regulatory prohibition (e.g. FCC in USA) of synchronizing master units in the Industry, Science and Medical Band (ISM 2.4 GHz), however, means that operation between cells must remain uncoordinated. It will be noted, however, that all the embodiments of the present invention can be used with the Bluetooth protocol. The features of such a system may include one or more of:
Slow frequency hopping as a spread spectrum technique;
Master and slave units whereby the master unit can set the hopping sequence;
Each device has its own clock and its own address;
The hopping sequence of a master unit can be determined from its address;
A set of slave units communicating with one master all have the same hopping frequency (of the master) and form a piconet;
Piconets can be linked through common slave units to form a scatternet;
Time Division Multiplex Transmissions (TDMA) between slave and master units;
Time Division Duplex (TDD) transmissions between slaves and masters units;
Transmissions between slave and master units may be either synchronous or asynchronous;
Master units determine when slave units can transmit;
Slave units may only reply when addressed by a master unit;
The clocks are free-running;
Uncoordinated networks, especially those operating in the 2.4 GHz license-free ISM band;
A software stack to enable applications to find other Bluetooth devices in the area;
Other devices are found by a discovery/inquiry procedure; and
Hard or soft handovers.

With regard to frequency hopping, “slow frequency hopping” refers to the hopping frequency being slower than the modulation rate, “fast frequency hopping” referring to a hopping rate faster than the modulation rate. The present invention is not limited to either slow or fast hopping.

Referring to the figures and for the moment in particular to FIG. 1, a communications system 10 is arranged in accordance with the Bluetooth standard in the form of a shared resources network, for example, a local area network LAN 12, e.g. according to the Ethernet standard. The LAN 12 includes a series of master units in the form of access points AP₁₋₄, which are inter-connected by the fixed or wireless network LAN 12 and are under the control of a host controller H.

User terminals MT₁₋₃ may be fixed or mobile. If mobile their entry into the area covered by the LAN 12 listen out for inquiry messages transmitted from the access points AP₁₋₄. The mobile terminals MT₁₋₃ often interact with the access points AP₁₋₄ by joining into piconets #1, #2 with them in an uncoordinated cellular relationship, i.e. in accordance with communications techniques such as those advocated in the Bluetooth protocol.

In the particular scenario depicted in FIG. 1, a first user terminal MT1 is shown connected in a piconet #1 with a first access point AP₁ and interacting (dashed double-ended arrows) with that access point AP₁ as a slave unit in order to gain access to the LAN 12. In similar fashion, a further mobile terminal MT2 is joined as a slave unit in the same piconet #1 as the first mobile terminal MT1, but is also joined in a second piconet #2 with a further access point AP2 acting as its master unit in that arrangement #2.

The user terminals MT1,2 which are already in the coverage of the LAN 12 are depicted by way of example as out of range of all other access points AP_{3,4} in the system and a third user terminal MT3 is depicted as out of range of all access points AP₁₋₄. This terminal MT3 is approaching the coverage area of at least the first access point AP₁, but is not yet in range to receive inquiry messages and cannot therefore be paged and enter into a connected state, joining into that master's piconet #1.

Referring now also to FIG. 2, the access points AP₁₋₄ move periodically from a connection standby condition into an inquiry mode in which they at least periodically transmit inquiry messages to look for potential slave units in range for connection into a new or existing piconet #1, #2. The inquiry message can be transmitted in a format which complies with the current Bluetooth protocol and is transmitted twice on two frequencies in one protocol timeslot, an immediately following timeslot being used to listen on two corresponding inquiry response frequencies for replies from further devices such as potential slave units in the form of mobile terminals MT1-3. A Bluetooth timeslot is in the region of 625 μS, compatible with a hopping frequency in the region of 1600 hops per second.

On or after entering into range of an access point AP₁₋₄, a mobile terminal MT1,2 is liable to receive such inquiry messages and, assuming it wishes to be found, will reply to one or more inquiry messages with an identifier in the form of an identity package in which the mobile terminal MT1,2 provides to the or each inquiring access point AP₁₋₄ information which enables the inquiring access point AP₁₋₄ to page that mobile terminal MT1,2. After sending the inquiry response information, the mobile terminal MT1,2 enters into a page scan state in which it waits on a substantially fixed page scan frequency fₚₛ to be paged by an access point AP₁₋₄.

In the event that an access point already holds enough information to page a potential slave unit MT1-3, it may do so without going through the inquiry procedure. Such a situation may occur, for example, if there has been prior communication between an access point AP₁₋₄ and a particular mobile terminal MT1-3, but that communication is broken by a link failure. If such a situation is detected quickly enough for clock drift not to be a serious issue, then that access point AP₁₋₄ can page the particular mobile terminal MT1-3 directly and without necessarily going through the inquiry procedure. This can be done on the basis that the inquiry information about address and clocking of the mobile terminal, held in the access point AP₁₋₄ from its previous connection establishment with that mobile terminal MT1-3, will still be accurate enough for paging it.

Whenever the paging sequence of a paging access point and the page scan sequence of a paged potential slave unit coincide, the mobile terminal MT1,2 concerned should receive an identity packet (ID) from the paging device AP₁₋₄. At this stage, the mobile terminal MT1,2 immediately acknowledges with another ID packet of its own and, assuming the paging device AP₁₋₄ receives the second ID packet from the paged device MT1,2, both parties will be in short “page response” states. There is one for the or each access point AP₁₋₄ and one for the or each potential slave MT1,2, but both use the same clock, frozen at the time of successful ID exchange. This freezing takes account of the fact that the actual value of the slave's clock and the master's estimate of the value of the same clock may not always exactly coincide. They both just step through the hopping sequence one at a time, so that they can be sure they are working together. During this response state, the master AP₁₋₄ sends its accurate timing information in a frequency hop synchronization (FHS) packet, which should be acknowledged by the slave MT1-3 with another ID packet. All the required information for entry into the connected state has by then been exchanged and the pager AP₁₋₄ and the paged device MT1,2 move into the connection state using the same extended pseudo-random hopping sequence, which has a period in the order of one day. In the connected state, the access points AP₁₋₄ and successfully paged and connected mobile terminals MT1,2 interact and data packages can be exchanged within the piconets #1,2 in accordance with the Bluetooth protocol.

The communications arrangement as depicted to date could be implemented using only one wireless module, e.g. one Bluetooth module in each access point AP₁₋₄ to perform all three communications tasks in sequence, i.e. inquiry, paging and interaction. This could lead to congestion in the access point AP₁₋₄, for example in situations in which it receives from mobile terminals multiple requests for connection and/or handoff. To this end, each access point AP₁₋₄ has included in it a plurality of wireless modules, e.g. Bluetooth radio communications modules. These modules form an integrated group, in which each member is dedicated to an individual wireless communications task. Such a situation is shown with respect to one exemplary access point AP₁ with particular reference now also to FIGS. 3 and 4.

In the exemplary access point AP₁, three wireless, e.g. Bluetooth radio modules have been integrated into that one access point and each one is configured for an individual wireless communications task. One module is an inquirer module 14, a second is a pager module 16 and the third is an interactor module 18. Bach access point AP₁₋₄ so constructed and configured, includes a substantially secure communications channel 20 linking said inquiry, paging and interactor modules 14, 16, 18. This channel 20 is used for the transfer of data between at least themselves. A secure connection may be achieved by attaching the modules 14, 16, 18 to the same host processor and ensuring that data can be transferred from one wireless module 14, 16, 18 to the others by means of this host processor H.

The inquirer module 14 is dedicated purely to discovering further devices for potential connection to its associated access point APSE. For transmitting inquiry messages, the inquirer module 14 is adapted to perform an inquiry procedure compatible with a suitable protocol such as the Bluetooth protocol. These messages are transmitted at least periodically but, as it is dedicated to only inquiry, the inquirer module 14 preferably operates in a substantially continuous inquiry state in which inquiry messages IQ₁₋ₙ are transmitted substantially continuously. As discussed above, the or each inquiry message IQ1 is transmitted twice on two frequencies in one Bluetooth timeslot and an immediately following timeslot is used to listen for replies from potential slave units, such as Bluetooth enabled mobile terminals MT1-3, although the present invention is not limited thereto.

In the event that a mobile terminal MT3 is not in range of the inquiry messages IQ₁₋ₙ, it is unable to receive or reply until it has come into the coverage of the access point AP₁. For a mobile terminal MT1 which is in range but is as yet unconnected to that access point AP₁, if it wishes to be discovered it must reply to an inquiry message IQ1 with an identifier, such as an identity packet containing the information about itself called for in the communications protocol, e.g. the Bluetooth protocol. The mobile terminal MT1 then enters into a substantially continuous page scan, in which it waits on a substantially fixed page scan frequency to be paged by the inquiring access point AP₁.

It will be noted here that the or each paging message will be transmitted by the paging module 16, although the mobile terminal MT1 being paged does not necessarily know that the tasks of inquiry, paging and interaction are being performed by separate modules within the access point. For the transition between the inquirer and the pager modules, there is no need for the mobile terminal MT to have any knowledge of the transfer as it is all internal to the access point. For the hand-over between the pager 16 and the interactor 18 modules, it is considered useful to implement this using the PAN profile although other techniques are not excluded whether implemented using hardware, software or a combination thereof.

It will be remembered here that the inquiry phase of a Bluetooth connection process does not establish any connection between the inquiring device and any mobile terminal responding to an inquiry, only the paging phase can do this. To this end, the inquiry information gathered by the inquirer is communicated to the pager module 16 via the communications channel 20. The inquiry information, including for example a device address and clock offset extracted from the identity packet supplied by the mobile terminal MT1, enables the pager module 16 to page the potential slave unit MT1 concerned. The inquirer module 14 continues to transmit inquiry messages IQ₁₋ₙ while the pager module 16 pages any one or more further devices MT which have responded to an inquiry message transmitted earlier.

The pager module 16 is dedicated purely to establishing connections with potential slave units MT1-3. These connections may be performed using information previously gathered by the inquirer module 14 and communicated or transferred to the pager module 16. Reference to the inquirer module 14 may not necessarily take place, however, if sufficient information is available to the pager module 16 such that it can page the potential slave unit MT1 directly. That information may for example be the mobile terminal's address. Again in similar fashion to the above, the or each paging message PG1 is transmitted twice on two frequencies in one Bluetooth timeslot, with the immediately following time slot being used to listen for replies from the paged device MT1.

On receipt of a paging message PG1, the mobile terminal MT1 concerned replies with a response packet containing synchronization information about itself, such as for example its device address and clock offset. The transmission of that response packet occurs substantially immediately on receipt by the mobile terminal MT1 of a paging message PG1 and is preferably transmitted a plurality of times.

It will be noted that, after the paging stage, it may be preferable to authenticate the mobile terminal MT, e.g. for security purposes. This security clearance might involve further communication across the shared resources network (e.g. LAN), e.g. with a remote server, and might therefore take up valuable time. It will therefore be seen that the provision of a dedicated pager module 16 could save time by handling this aspect of connection separately and reduce potential delays to further inquiry trains or interconnections. This security clearance may be performed, for example, by the paging module and substantially immediately, or soon after, getting a response to its page train.

On receipt of the response packet from a potential slave unit, the pager module 16 establishes a connection to that unit, the connection establishment including one or more, and preferably all, of setting up a radio link, authenticating the mobile terminal MT1 and performing a service discovery procedure for that mobile terminal MT1. Once a connection has been established by the pager module 16, the newly connected mobile terminal MT1 is handed over inside the access point AP₁ to the interactor module 18 using the communication channel 20.

The interactor module 18 is dedicated purely to interaction between connected mobile terminals MT1,2 and the LAN 12. The interaction may take the form of exchanging data packets IA1, IA2 between the interactor module 18 and the connected mobile terminals MT1, 2.

The interactor module 18 is substantially immune to the ongoing actions of the other modules 14, 16 in the group. This is necessary to ensure that there is substantially no interference from those modules 14, 16 on existing connections between the interactor module 18 and any other mobile terminals MT2 which are interacting using a connection IA2 established by an earlier transmitted paging message. The immunity is achieved by setting the interactor module to a non-discoverable and non-connectable state, such that a mobile device MT that performs an inquiry does not discover the interactor module 18 or succeed in establishing a connection with it.

All the integrated modules 14, 16, 18 communicate with the same host processor H through the standard Bluetooth host controller interface (HCI). HCI can be mapped on a universal asynchronous receiver/transmitter (UART), which means that three high-speed serial links are used to enable communication between the same host and each of the modules. The host processor H runs the higher layers of the Bluetooth stack (HCI, L2CAP and above) in such a way that data, commands and events from the integrated modules 14, 16, 18 can be processed by the same central processing unit (CPU). Due to limitations in the throughput of the current Bluetooth standard, this can be accommodated by many modem CPU's. Because some modules 14 are only used to discover new clients (mobile terminals), they 14 are only activated using the inquiry command and they return events only to the host H.

In order for communication to happen, a control software component (CSC) is implemented in the host H which knows the status of each module 14, 16, 18 and performs actions depending on the events received from the various modules 14, 16, 18 received through the HCI. This will now be described by way of example for a situation in which an inquirer module 14 discovers a new mobile unit MT3 coming into range. Firstly, an HCI event is generated and then the CSC receives this event from the inquirer module 14 and reacts by sending a paging command. The paging command is sent through the HCI using a serial line that connects the host H to the pager module 16. When the pager module 16 has established a link to and authenticated the new device MT3, the CSC can hand over the new client MT3 to the interactor module 18. The role of the access point AP1 is mapped to its integrated BT modules 14, 16, 18 and handover may be performed from the network side, not because a link becomes bad but to simplify the assignment of a new master to the same client.

It will be appreciated that the provision of a plurality of cooperating wireless, e.g. radio modules 14, 16, 18 integrated into the same access point AP₁ and dedicated to individual wireless communications tasks provides a cost effective arrangement for increased throughput in connection establishment and for interaction. Chassis and connectivity can be shared, thus taking advantage of for example, low Bluetooth module costs to realize performance improvements at nodes in the system by increasing their capacity, along with potential savings in component packaging over the cost of equivalent performance in prior art arrangements. It will now no longer be necessary to wait for a pause in interaction LA2 with an already connected module MT2 or for each stage of a connection establishment procedure IQ1, PG1 with one mobile terminal MT1 to be completed before a new procedure can be started with a new or queuing mobile terminal MT3. Indeed, several connections may be attempted in parallel across all three phases of the connection establishment, e.g. while the interactor module 18 is interacting IA2 with an already connected mobile terminal MT2, the inquirer module 14 may be transmitting inquiry messages IQ₁₋ₙ and the pager module 16 transmitting page messages PG1 in parallel to set up a connection with a potential slave unit MT1 which has responded to earlier inquiry IQ1.

While the present invention has been particularly shown and described with respect to a preferred embodiment, it will be understood by those skilled in the art that changes in form and detail may be made without departing from the scope and spirit of the invention. For example, the present invention is not limited to the use of only three radio modules, 14, 16, 18 in each access point. It may indeed be found useful to increase the number of dedicated modules in one or more of the groups, depending on the particular circumstances or use of the access point concerned. It may also be found useful to configure one or more of the modules 14, 16, 18 for performing only one of the tasks only temporarily, so as for example to maintain sufficient flexibility to take account of transient demands which might call temporarily for two pager modules and only one interactor.

1. A communications arrangement comprising a first wireless communications device which is adapted to search for further wireless communications devices in range for connection thereto by transmission of an inquiry message in accordance with a predetermined protocol, and a said further wireless device in receipt of a said inquiry message being adapted to reply with an identifier, said first wireless device being adapted on receipt of said identifier to page said further wireless device and thereby to establish interaction therewith, characterized in that said first wireless device includes a group of wireless communications modules each of which is configured at least temporarily to perform an individual wireless communications task, said group comprising at least one each of an inquirer module, a pager module and an interactor module.

2. An arrangement according to claim 1, wherein said inquirer module is dedicated purely for discovery of potential said further wireless devices and is adapted to perform an inquiry procedure in which it transmits inquiry messages at least periodically and preferably substantially continuously.

3. An arrangement according to claim 2, wherein the or each said inquiry message is transmitted twice on two frequencies in one protocol timeslot and an immediately following protocol timeslot is preferably used to listen for replies from further wireless devices on two corresponding inquiry response frequencies.

4. An arrangement according to claim 1, wherein inquiry information collected by said inquirer module and relating to a said discovered potential further wireless device is communicated to said pager module, which inquiry information enables said pager module to page the or each said potential further wireless device.

5. An arrangement according to claim 1, wherein, after replying to a said inquiry with a said identifier, a said further wireless device enters into a page scan state in which it waits on a substantially fixed page scan frequency to be paged by a said pager module.

6. An arrangement according to claim 1, wherein said pager module is dedicated purely to establishment of a connection with one or more potential said further wireless devices, a said attempted connection preferably being performed using a paging message based on inquiry information which has previously been collected by said inquirer module and communicated to said paging unit or, if inquiry information such as a device address of one or more potential further wireless devices is substantially known to said first wireless device without the need for an inquiry process, said pager module is preferably adapted to page the or each said substantially known further wireless device directly and without necessarily communicating with said inquirer module.

7. An arrangement according to claim 6, wherein the or each said paging message is transmitted twice on two frequencies in one respective protocol timeslot and an immediately following protocol timeslot is used to listen for replies from the respectively paged further wireless device.

8. An arrangement according to claim 6, wherein a said potential further wireless device responds to paging by return of a response packet containing synchronization information about itself, preferably including its device address and transmission of said response packet preferably occurring substantially immediately on reception of a said paging message and said response message also preferably being transmitted a plurality of times.

9. An arrangement according to claim 6, wherein the establishment of a said connection includes one or more of the setting up of a wireless link, authentication of said further wireless device and a service discovery procedure and, on establishment by said pager module of a said connection with a said further wireless device, that further device is preferably handed over from said pager module to a said interactor module.

10. An arrangement according to claim 1 wherein a said interactor module is dedicated purely to interaction between said communications device and a connected said further wireless device, said interaction including for example the exchange of data packets between said interactor module and said connected further wireless device.

11. An arrangement according to claim 10, wherein at least one existing connection between a said interactor module and a said further wireless device is substantially unaffected by the performance of respective said tasks by at least one and preferably either of said inquirer and pager modules.

12. An arrangement according to claim 1, wherein said inquirer module is adapted to transmit a further said inquiry message while a said pager module pages a potential said further wireless device which has responded to a said inquiry message transmitted earlier.

13. An arrangement according to claim 1, wherein said communications device includes a substantially secure communications channel linking said inquiry, pager and interactor modules for the transfer of data therebetween.

14. An arrangement according to claim 1, wherein said pager module authenticates, or implements a security clearance check on, a paged said further wireless device.

15. A method of establishing a wireless connection between a first wireless communications device and one or more further wireless communications devices, said first wireless device having integrated therein a group of at least three wireless communications modules, the method including:
a) configuring each said module for performing a dedicated wireless communications task, said tasks comprising one per module of inquiring, paging and interacting;
b) transmitting inquiry messages from an inquirer module of said group;
c) paging a said further wireless device using a pager module of said group; and
d) interacting with one or more said further wireless devices using an interactor module of said group.

16. A communications device for use in an arrangement according to claim 1, said device being configurable at least temporarily as a master unit of a communications network and adapted to transmit an inquiry message to search for further communications devices, such as slave units, which are in communications range for connection thereto, characterized in that said first wireless device includes a group of wireless communications modules each of which is configured at least temporarily to perform an individual wireless communications task, said group comprising at least one each of an inquirer module, a pager module and an interactor module.

17. An arrangement according to claim 1, wherein said communications device comprises an access point of a shared resources network and a said further communications device preferably comprises a user terminal of said shared resources network.
